(19) United States
(12) Patent Application Publication
(10) Pub. No.: US 2011/0181841 A1
(43) Pub. Date: Jul. 28, 2011

(54) AUTOFOCUS IMAGE PROJECTION APPARATUS

(75) Inventor: Takashi Sawahata, Utsunomiya-shi (JP)

(73) Assignee: CANON KABUSHIKI KAISHA, Tokyo (JP)

(21) Appl. No.: 13/014,162

(22) Filed: Jan. 26, 2011

(30) Foreign Application Priority Data
Jan. 27, 2010 (JP) 2010-015140

(51) Int. Cl. G03B 3/12; G03B 21/14

(52) U.S. Cl. 353/31

(57) ABSTRACT

The image projection apparatus includes a color separation/combination unit separating light into color lights to introduce them to light modulation elements and combining the lights modulated by the light modulation elements, a projection optical system projecting projection light that is the combined color lights onto a projection surface, an image-pickup element capturing a projected image, and a controller performing AF by using an output from the image-pickup element. The color separation/combination unit includes an optical film surface reflecting or transmitting at least one of the color lights and a non-effective surface. The image-pickup element is disposed so as to face the non-effective surface and captures the projected image using detection light of the projection light, which is reflected at the projection surface to enter the color separation/combination unit through the projection optical system and is transmitted through or reflected at the film surface to exit through the non-effective surface.

### BACKGROUND OF THE INVENTION

1. Field of the Invention

The present invention relates to an image projection apparatus such as a projector, and particularly to an image projection apparatus having an autofocus (AF) function for its projection optical system.

2. Description of the Related Art

Projectors modulate light from a light source by a light modulation element such as a liquid crystal panel and project the modulated light through a projection optical system (projection lens) onto a projection surface such as a screen to display an image. Such projectors include one having an AF function to automatically adjust a focus state of the projection optical system in order to display an in-focus image regardless of a distance to the projection surface (projection distance).

Japanese Patent No. 2919585 discloses a projector that includes a half-mirror disposed in an optical path between a projection lens and a liquid crystal panel, and captures a projected image formed on a projection surface by an image-pickup element through the half-mirror to perform AF based on an image-pickup output of the image-pickup element.

Moreover, Japanese Patent Laid-Open No. 05-197014 discloses a projector that receives, by a photoelectric sensor disposed between liquid crystal cells of a liquid crystal panel, light which is a light component of projected light and enters the projector through a projection optical system after reflection at a projection surface. This projector performs AF so as to minimize an intensity of the light received by the photoelectric sensor.

However, the projector disclosed in Japanese Patent No. 2919585 requires a dedicated optical member for forming an optical path to introduce light from the half-mirror to the image-pickup element, which increases in size of the projector. Moreover, Japanese Patent No. 2919585 describes that the half-mirror is moved out of the optical path when the AF is not performed. This requires a space to retract the half-mirror, which makes the projector larger in size.

Furthermore, the projector disclosed in Japanese Patent Laid-Open No. 05-197014 uses a special liquid crystal panel in which the photoelectric sensor is disposed between the liquid crystal cells, and the photoelectric sensor reduces an aperture ratio of the liquid crystal panel as compared with general liquid crystal panels. The reduction of the aperture ratio invites deterioration of basic performances of the projector such as reduction of brightness of projected images. Increasing the aperture ratio needs reduction of resolution or increase in size of the liquid crystal panel, which prevents achievement of a small and high-resolution projector.

### SUMMARY OF THE INVENTION

The present invention provides an image projection apparatus capable of performing good AF while suppressing increase in size of the apparatus and reduction of display resolution.

The present invention provides as one aspect thereof an image projection apparatus including a color separation/combination unit configured to separate light from a light source into plural color lights to introduce them to plural light modulation elements and configured to combine the plural lights modulated by the light modulation elements, a projection optical system configured to project projection light that is the combined color lights from the color separation/combination unit onto a projection surface, an image-pickup element configured to capture a projected image formed by the projection light projected onto the projection surface, a controller configured to automatically control focusing of the projection optical system by using an output from the image-pickup element. The color separation/combination unit includes an optical film surface that reflects or transmits at least one of the plural color lights and a non-effective surface that does not reflect and transmit any of the plural color lights. The image-pickup element is disposed so as to face the non-effective surface and is configured to capture the projected image by using detection light that is a light component of the projection light, the detection light being reflected at the projection surface to enter the color separation/combination unit through the projection optical system and then being transmitted through or reflected at the optical film surface to exit the color separation/combination unit through the non-effective surface.

Further features of the present invention will become apparent from the following description of exemplary embodiments with reference to the attached drawings.

### BRIEF DESCRIPTION OF THE DRAWINGS

FIG. 1 is an external view of a liquid crystal projector that is Embodiment 1 of the present invention.

FIG. 2 is a side view showing an optical configuration of the liquid crystal projector of Embodiment 1.

FIG. 3 is an exploded perspective view of a color separation/combination unit in Embodiment 1.

FIG. 4 shows characteristics of a first polarization beam splitter in Embodiment 1.

FIG. 5 shows characteristics of a third polarization beam splitter in Embodiment 1.

FIG. 6 shows an optical path of a red light in Embodiment 1.

FIG. 7 shows an optical path of a red light in Embodiment 2 of the present invention.

### DESCRIPTION OF THE PREFERRED EMBODIMENTS

Exemplary embodiments of the present invention will hereinafter be described with reference to the accompanying drawings.

### Embodiment 1

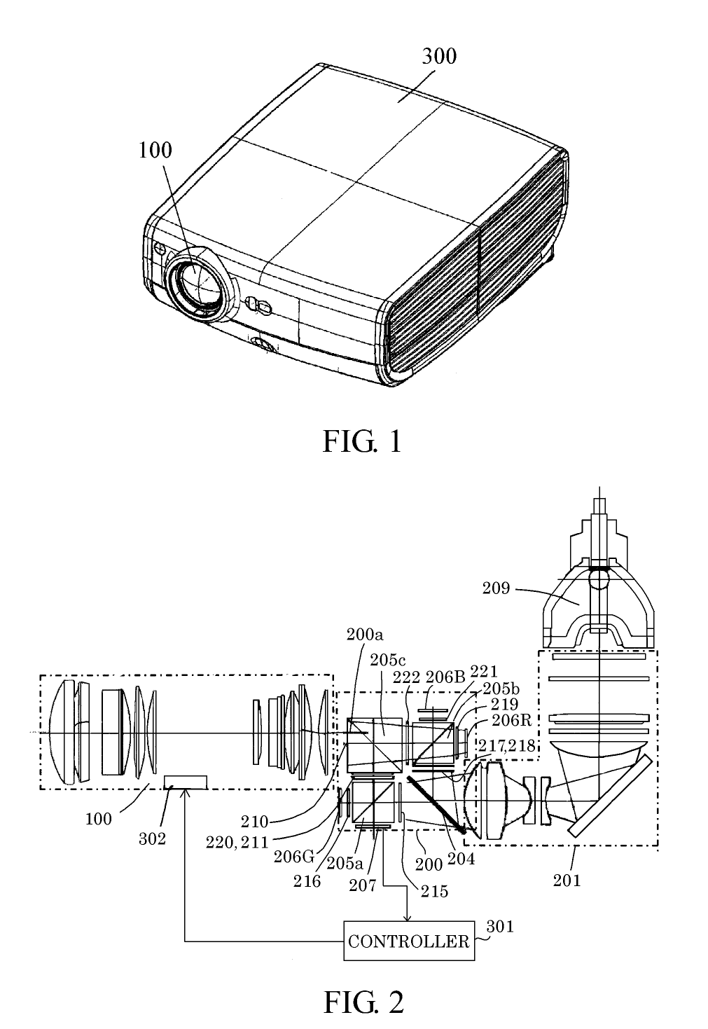

FIG. 1 shows a liquid crystal projector as an image projection apparatus that is a first embodiment (Embodiment 1) of the present invention. Reference numeral 300 denotes a chassis of the projector, and reference numeral 100 denotes a projection lens serving as a projection optical system.

FIG. 2 shows an optical configuration of the projector of Embodiment 1. Reference numeral 209 denotes a light source lamp, and reference numeral 201 denotes an illumination optical system. The illumination optical system 201 includes optical elements such as lenses for dividing illumination light from the light source lamp 209 into plural light fluxes and then overlapping them on liquid crystal panels which will be described later, and a polarization conversion element for converting the illumination light into polarized light having a predetermined polarization direction. The illumination optical system 201 further includes a mirror for bending an optical path in the illumination optical system 201.

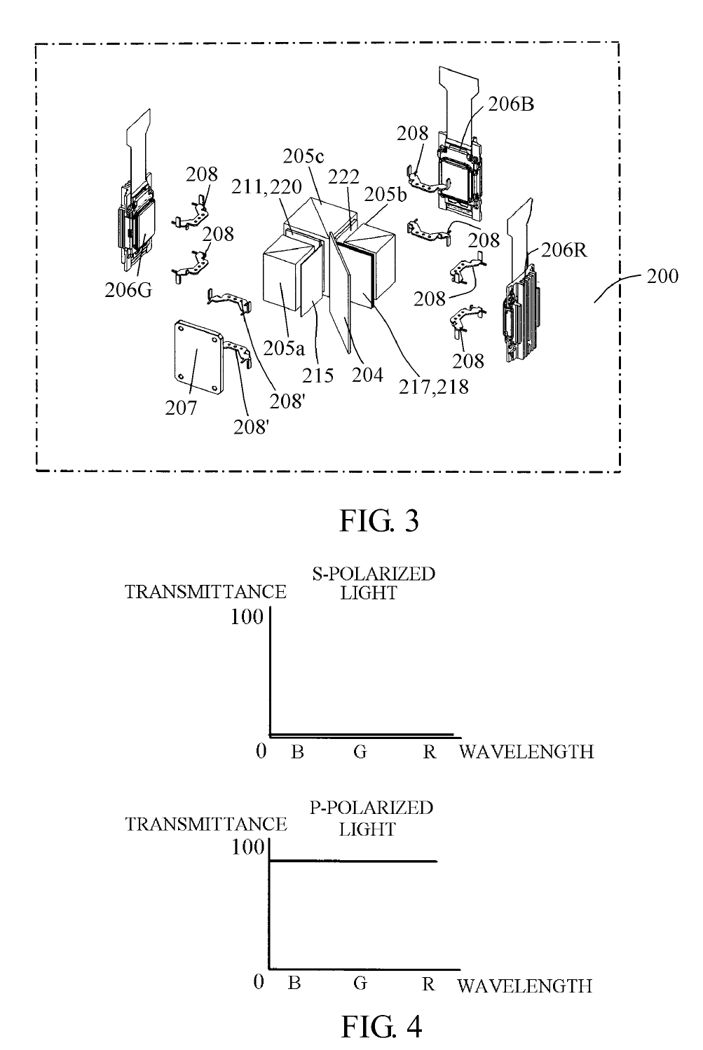

The light (light fluxes) exiting from the illumination optical system 201 enters a color separation/combination unit 200. FIG. 3 is an exploded view of the color separation/combination unit 200.

The color separation/combination unit 200 includes optical elements such as a dichroic mirror 204 and first to third polarization beam splitters 205a, 205b and 205c. The color separation/combination unit 200 separates the illumination light from the illumination optical system 201 into plural (three) color lights to introduce them to plural (three) reflective liquid crystal panels serving as light modulation elements. The color separation/combination unit 200 further combines the three color lights modulated by the three reflective liquid crystal panels into one light.

The dichroic mirror 204 reflects a blue (B) light and a red (R) light of a white light as the illumination light from the illumination optical system 201 (that is, from the light source lamp 209) and transmits a green (G) light of the white light. The first polarization beam splitter 205a is a prism having a polarization splitting surface (optical film surface) that transmits a P-polarized light and reflects an S-polarized light according to its characteristic shown in FIG. 4. The polarization splitting surface is a surface on which a polarization splitting film as a multilayer film is formed.

Reference numerals 206R, 206G and 206B respectively denote a reflective liquid crystal panel for R, a reflective liquid crystal panel for G and a reflective liquid crystal panel for B which are light modulation elements that reflect and image-modulate light entering thereinto. The liquid crystal panels 206R, 206G and 206B are respectively provided with quarter-wave plates 219, 216 and 221. Optical elements for R, G and B are hereinafter respectively referred to as “R-, G- and B-optical elements”, such as “R-, G- and B-reflective liquid crystal panels”.

Between the first polarization beam splitter 205a and the third polarization beam splitter 205c, a G-exit side polarizing plate 220 that transmits an S-polarized light and a G-color selective phase plate 211 that changes a polarization direction of the R light by 90 degrees and does not change a polarization direction of the G light are disposed.

Between the dichroic mirror 204 and the second polarization beam splitter 205b, an RB-entrance side polarizing plate 217 that transmits only a P-polarized light and an R-color selective phase plate 218 that changes the polarization direction of the R light by 90 degrees and does not change a polarization direction of the B light are disposed.

The second polarization beam splitter 205b is, as with the first polarization beam splitter 205a, a prism having a polarization splitting surface (optical film surface) that transmits a P-polarized light and reflects an S-polarized light.

Between the second polarization beam splitter 205b and the third polarization beam splitter 205c, a B-exit side polarizing plate 222 is disposed. The B-exit side polarizing plate 222 transmits only an S-polarized light of the B light and transmits the R light regardless of its polarization direction.

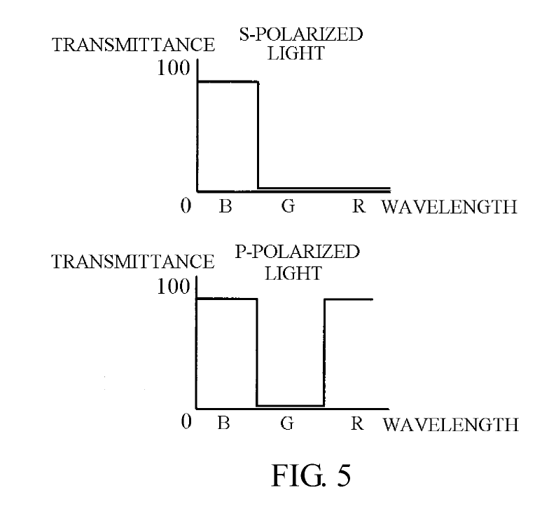

As shown in FIG. 5, the third polarization beam splitter 205c is a prism serving as a dichroic mirror that transmits the B light and reflects the G light, and having a color selective polarization splitting surface (optical film surface) that transmits a P-polarized light of the R light and reflects an S-polarized light thereof.

In each polarization beam splitter, the polarization splitting surface that transmits or reflects at least one of the R, G and B lights (illumination light) proceeding toward the liquid crystal panels and at least one of the R, G and B lights (modulated light) proceeding from the liquid crystal panels to the projection lens 100 is an optically effective surface for image projection in the color separation/combination unit 200. Moreover, among external surfaces of the prism constituting each of the first to third polarization beam splitters 205a to 205c, surfaces that transmits the illumination light or the modulated light are also optically effective surfaces for image projection. On the other hand, among the external surfaces of the prism, surfaces that do not transmit the illumination light or the modulated light are non-effective surfaces for image projection.

As shown in FIG. 3, the G-liquid crystal panel 206G is held by upper and lower two holding members 208. These two holding members 208 are fixed by bonding to the prism such that the G-liquid crystal panel 206G faces one external surface (optically effective surface) of the prism of the first polarization beam splitter 205a. To fix the holding members 208 to the prism, the holding members 208 are brought closer to the prism from a direction orthogonal to the external surface which is to face the G-liquid crystal panel 206G, and then legs of the holding members 208 are bonded to the prism. Thereby, the holding members 208 are fixed to the prism.

The R- and B-liquid crystal panels 206R and 206B are held by respective other upper and lower two holding members 208. These holding members 208 are fixed by bonding to the prism of the second polarization beam splitter 205b such that the R- and B-liquid crystal panels 206R and 206B face two external surfaces (optically effective surfaces) of the prism. A method (attaching method) for fixing the holding members 208 to the prism of the second polarization beam splitter 205b is same as that for fixing the holding member 208 holding the G-liquid crystal panel 206G to the first polarization beam splitter 205a.

Reference numeral 207 denotes an image-pickup element as a photoelectric conversion element such as a CCD sensor or a CMOS sensor. The image-pickup element 207 is held by holding members 208′ having a same configuration as that of the holding members 208 for holding each liquid crystal panel. The same configuration means that a shape and a size of the holding member 208′ are same as those of the holding member 208 and a way to hold the image-pickup element 207 is same as that of the holding member 208.

The holding members 208′ are fixed to the prism of the first polarization beam splitter 205a by a same fixing method (attaching method) as that for the holding members 208 holding each liquid crystal panel such that the image-pickup element 207 faces one external surface (non-effective surface) other than the optically effective surface in that prism. The same fixing method means bringing the holding member 208′ closer to the prism from a direction (same direction) orthogonal to the external surface which is to face the image-pickup element 207, and then bonding legs of the holding members 208′ to the prism.

Next, description will be made of optical actions of the color separation/combination unit 200. The G light that has been transmitted through the dichroic mirror 204 of the illumination optical system 201 is transmitted through a G-entrance side polarizing plate 215 to enter the first polarization beam splitter 205a, and a P-polarized light thereof is transmitted through the polarization splitting surface of the first polarization beam splitter 205a to reach the G-liquid crystal panel 206G. A P-polarized light of the G light that has been reflected and image-modulated by the G-liquid crystal panel 206G is again transmitted through the first polarization beam splitter 205a to be returned toward the light source, thereby being removed from projection light.

On the other hand, an S-polarized light (modulated light) of the G light that has been image-modulated is reflected by the polarization splitting surface of the first polarization beam splitter 205a, transmitted through the G-exit side polarizing plate 220 and the color selective phase plate 211 to proceed toward the third polarization beam splitter 205c as the projection light. In a state where the entire polarized light is converted into the P-polarized light (that is, a state of displaying a black image), a slow axis of the quarter-wave plate 216 disposed between the first polarization beam splitter 205a and the G-liquid crystal panel 206G is adjusted. This adjustment of the slow axis makes it possible to suppress influences of turbulence of a polarization state generated in the first polarization beam splitter 205a and the G-liquid crystal panel 206G.

The G light (S-polarized light) proceeding from the first polarization beam splitter 205a toward the third polarization beam splitter 205c is analyzed by the G-exit side polarizing plate 220, and then is reflected by the polarization splitting surface of the third polarization beam splitter 205c to be introduced to the projection lens 100.

On the other hand, the R and B lights that have been reflected by the dichroic mirror 204 enter the RB-entrance side polarizing plate 217 to be transmitted therethrough, and then enter the R-color selective phase plate 218. The R light whose polarization direction has been changed by 90 degrees by the R-color selective phase plate 218 enters the second polarization beam splitter 205b as an S-polarized light, and the B light whose polarization direction is not changed by the R-color selective phase plate 218 enters the second polarization beam splitter 205b as a P-polarized light.

The R light that has entered the second polarization beam splitter 205b as the S-polarized light is reflected by the polarization splitting surface thereof to reach the R-liquid crystal panel 206R. The B light that has entered the second polarization beam splitter 205b as the P-polarized light is transmitted through the polarization splitting surface thereof to reach the B-liquid crystal panel 206B.

An S-polarized light of the R light that has been reflected and image-modulated by the R-liquid crystal panel 206R is again reflected by the polarization splitting surface of the second polarization beam splitter 205b to be returned toward the light source, thereby being removed from the projection light. On the other hand, a P-polarized light (modulated light) of the R light that has been image-modulated is transmitted through the polarization splitting surface of the second polarization beam splitter 205b, and is transmitted through the B-exit side polarizing plate 222 as the P-polarized light without being changed to proceed toward the third polarization beam splitter 205c as the projection light.

Moreover, a P-polarized light of the B light that has been reflected and image-modulated by the B-liquid crystal panel 206B is again transmitted through the polarization splitting surface of the second polarization beam splitter 205b to be returned toward the light source, thereby being removed from the projection light. On the other hand, an S-polarized light (modulated light) of the B light that has been image-modulated is reflected by the polarization splitting surface of the second polarization beam splitter 205b is analyzed by the B-exit side polarizing plate 222, and then proceeds toward the third polarization beam splitter 205c as the projection light.

Adjusting a direction of the slow axes of the quarter-wave plates 219, 221 disposed between the second polarization beam splitter 205b and the R- and B-liquid crystal panels 206R and 206B enables suppression of influences of turbulence of polarization states generated in the second polarization beam splitter 205b and the R- and B-liquid crystal panels 206R and 206B.

The R light that is the P-polarized light and the B light that is the S-polarized light are transmitted through the polarization splitting surface of the third polarization beam splitter 205c to be combined with the G light. The projection lens 100 enlarges and projects the projection light thus combined onto the projection surface such as a screen.

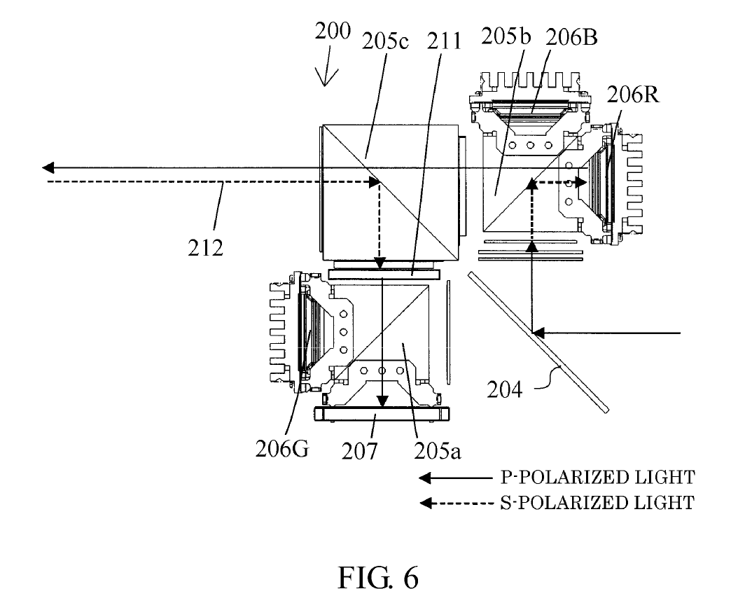

FIG. 6 shows an optical path of the R light that is separated from the light from the illumination optical system 201 by the color separation/combination unit 200, image-modulated by the R-liquid crystal panel 206R and combined with the other color lights by the color separation/combination unit 200 to be projected onto the projection surface through the projection lens 100, and an optical path of the R light that is reflected by the projection surface to reach the image-pickup element 207. In the figure, solid line arrows show optical paths of the P-polarized light, and dotted line arrows show optical paths of the S-polarized light.

As described above, the R light from the illumination optical system 201 is reflected by the dichroic mirror 204, and then introduced to the R-liquid crystal panel 206R through the second polarization beam splitter 205b. The R light as the P-polarized light that has been image-modulated by the R-liquid crystal panel 206R is transmitted through the polarization splitting surfaces of the second and third polarization beam splitters 205b and 205c to be projected onto the projection surface through the projection lens 100.

The R light projected onto the projection surface is reflected thereby to become light including light components having various polarization directions. Of the light components, a light component (reflected light) 212 entering the projection lens 100 as an S-polarized light reaches the third polarization beam splitter 205c. The polarization splitting surface of the third polarization beam splitter 205c has the characteristic that it transmits the P-polarized light of the R light and reflects the S-polarized light thereof as described above. Thus, the reflected light 212 as the S-polarized light is reflected by the polarization splitting surface of the third polarization beam splitter 205c, transmitted through the G-exit side polarizing plate 220, and then enters the color selective phase plate 211 that converts only the polarization direction of the R light by 90 degrees. The reflected light 212 converted into a P-polarized light by the color selective phase plate 211 proceeds toward the first polarization beam splitter 205a.

As described above, the first polarization beam splitter 205a has the characteristic that it transmits the P-polarized light and reflects the S-polarized light. Therefore, the reflected light 212 as the P-polarized light is transmitted through the polarization splitting surface of the first polarization beam splitter 205a to reach the image-pickup element 207. This reflected light 212 enables the image-pickup element 207 to capture an optical image (R-optical image) of a projected image (R-projected image) formed by the R light in a full-color projected image formed on the projection surface.

The image-pickup element 207 photoelectrically converts the R-optical image to output an image-pickup signal (image-pickup output) to a controller 301 shown in FIG. 2. The controller 301 is constituted by a CPU or the like, and detects a focus state of the R-projected image from a contrast component or a luminance component included in the image-pickup signal. Then, the controller 301 operates, based on the detection result of the focus state, a focus motor that is an actuator installed in the projection lens 100. Thus, a focus lens included in the projection lens 100 is moved in an optical axis direction to perform autofocus (AF) of the projection lens 100.

Thus, this embodiment performs capturing of the R-projected image (R-optical image) by the image-pickup element 207 by using the R light (detection light) that enters the image-pickup element 207 through the projection lens 100 and the color separation/combination unit 200 from the projection surface, and performs the AF on the basis of the image-pickup output.

In the capturing of the R-projected image, in the color separation/combination unit 200, the R light is reflected by the polarization splitting surface of the third polarization beam splitter 205c, transmitted through the polarization splitting surface of the first polarization beam splitter 205a, and then transmitted through the non-effective surface of the second polarization beam splitter 205b to enter the image-pickup element 207. In other words, the image-pickup element 207 captures the R-projected image by using the detection light that is part of the projection light reflected by the projection surface, the detection light entering the color separation/combination unit 200 through the projection lens 100 and then being transmitted through or reflected by the optical film surface in the color separation/combination unit 200 to exit therefrom through the non-effective surface. Therefore, this embodiment can perform the AF without providing a dedicated optical element for introducing the R light from the projection surface to the image-pickup element 207.

Moreover, as described above, the image-pickup element 207 and the R-, G- and B-liquid crystal panels 205R, 205G and 205B are fixed by the holding members 208′ and 208 having the mutually same configuration and by the mutually same attaching method to the first and second polarization beam splitters 205a and 205b. Therefore, amounts of expansion or contraction of the holding members 208′ and 208 due to linear expansion are almost same when an interior temperature of the chassis 300 of the projector changes.

If configurations of the holding member 208′ for the image-pickup element 207 and the holding member 208 for the R-, G- and B-liquid crystal panels 205R, 205G and 205B or attaching methods therefor are different from each other, the amounts of expansion or contraction of these holding members 208′ and 208 due to the linear expansion are significantly different, which generates gaps between focus states of the captured image obtained by using the image-pickup element 207 and movement amounts of the focus lens in the AF. As a result, good AF cannot be performed.

On the other hand, this embodiment generates no gap between the focus states of the captured image obtained by using the image-pickup element 207 and the movement amounts of the focus lens in the AF, which enables good AF without being affected by temperature changes.

### Embodiment 2

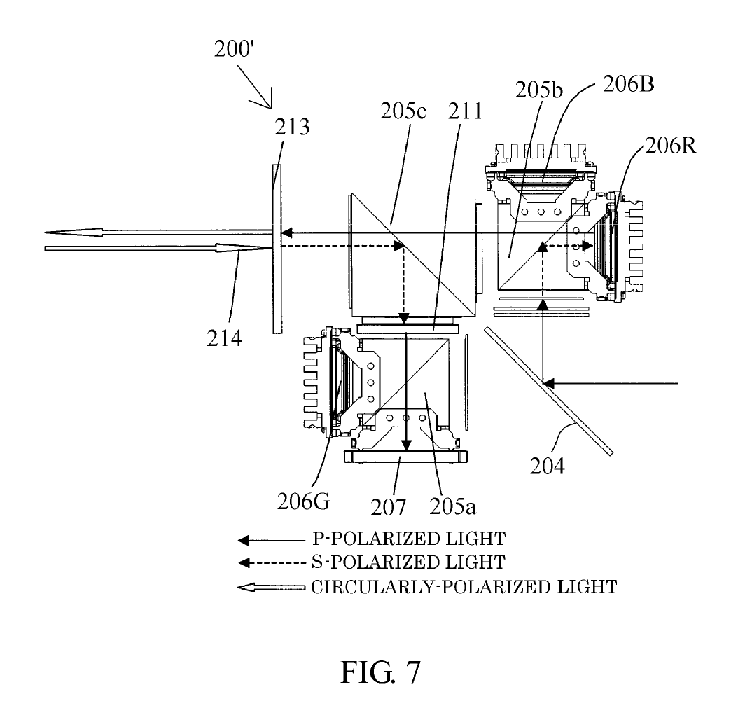

FIG. 7 shows a configuration of a color separation/combination unit 200′ in a second embodiment (Embodiment 2) of the present invention. In FIG. 7, components common to those shown in FIG. 6 are denoted by same reference numerals as those in FIG. 6, and descriptions thereof are omitted

FIG. 7 also shows an optical path of an R light that is separated from illumination light from an illumination optical system 201 by the color separation/combination unit 200′, image-modulated by an R-liquid crystal panel 206R and combined with other color lights by the color separation/combination unit 200′ to be projected onto a projection surface through a projection lens 100, and an optical path of the R light that is reflected by the projection surface to reach an image-pickup element 207. In the figure, solid line arrows show optical paths of a P-polarized light, dotted line arrows show optical paths of an S-polarized light, and white arrows show optical paths of a circularly-polarized light.

This embodiment includes a quarter-wave plate 213 that is disposed between a third polarization beam splitter 205c in the color separation/combination unit 200′ and the projection lens 100. The quarter-wave plate 213 is disposed such that its principal axis direction is inclined with respect to a polarization direction of the R light projected through the projection lens 100 by 45 degrees.

The R light separated by the color separation/combination unit 200′ is reflected and image-modulated by the R-liquid crystal panel 206R to become a P-polarized light, transmitted through the quarter-wave plate 213 to be converted into the circularly-polarized light, and then projected onto the projection surface through the projection lens 100. Of the R light reflected by the projection surface, a reflected light 214 entering the projection lens 100 is transmitted therethrough, and then transmitted through the quarter-wave plate 213 to be converted into an S-polarized light. The reflected light 214 as the S-polarized light enters the third polarization beam splitter 205c.

The R light entering the third polarization beam splitter 205c as the S-polarized light is reflected by the polarization splitting surface thereof, transmitted through a G-exit side polarizing plat 220 without being changed, enters a color selective phase plate 211 to be converted into a P-polarized light, and then proceeds toward the first polarization beam splitter 205a. The R light as the P-polarized light that has been transmitted through the polarization splitting surface of the first polarization beam splitter 205a exits from a non-effective area of a prism constituting the first polarization beam splitter 205a to enter the image-pickup element 207. Thus, this embodiment also performs capturing of an R-projected image by the image-pickup element 207 by using the R light (detection light) that enters the image-pickup element 207 through the projection lens 100 and the color separation/combination unit 200′ from the projection surface, and performs the AF on the basis of an image-pickup output from the image-pickup element 207.

The quarter-wave plate 213 may be disposed, instead of being disposed between the third polarization beam splitter 205c and the projection lens 100, between the third polarization beam splitter 205c and the projection surface (for example, a projection surface side part of the projection lens 100).

Although each of the above embodiments described the case where the AF is performed by using only the R light of the projection light reflected by the projection surface, the AF may be performed by using at least one of the G light and the B light instead of or with the R light.

Moreover, although each of the above embodiments described the case where the holding member for the image-pickup element is attached to the polarization beam splitter as the optical element, the holding member may be attached to an optical element other than the polarization beam splitter.

In addition, although each of the above embodiments described the case where the reflective liquid crystal panel is used as the light modulation element, other light modulation elements such as transmissive liquid crystal panels and digital micromirror devices (DMDs) may be used.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-015140, filed on Jan. 27, 2010, which is hereby incorporated by reference herein in its entirety.

What is claimed is:

1. An image projection apparatus comprising:
a color separation/combination unit configured to separate light from a light source into plural color lights to introduce them to plural light modulation elements and configured to combine the color lights modulated by the light modulation elements;
a projection optical system configured to project projection light that is the combined color lights from the color separation/combination unit onto a projection surface;
an image-pickup element configured to capture a projected image formed by the projection light projected onto the projection surface; and
a controller configured to perform autofocus of the projection optical system by using an output from the image-pickup element,
wherein the color separation/combination unit includes (a) an optical film surface that reflects or transmits at least one of the color lights and (b) a non-effective surface that does not reflect and transmit any of the color lights, and
wherein the image-pickup element is disposed so as to face the non-effective surface and is configured to capture the projected image by using detection light that is part of the projection light reflected at the projection surface, the detection light entering the color separation/combination unit through the projection optical system and then being transmitted through or reflected at the optical film surface to exit the color separation/combination unit from the non-effective surface.

2. An image projection apparatus according to claim 1,
wherein the color separation/combination unit includes an optical element having the optical film surface and the non-effective surface, and
wherein the light modulation elements and the image-pickup element are held by holding members having a mutually same configuration and being attached to the optical element with a mutually same attaching method.

3. An image projection apparatus according to claim 1,
wherein a quarter-wave plate is provided between the color separation/combination unit and the projection surface, the quarter-wave plate having a principal axis direction inclined at 45 degrees with respect to a polarization direction of a light component of the projection light which is used as the detection light.
